(19) United States
(12) Patent Application Publication
(10) Pub. No.: US 2014/0059860 A1
(43) Pub. Date: Mar. 6, 2014

(54) Method of mating composite structures without the use of through-structure fasteners

(71) Applicant: Thomas HSUEH, Anacortes, WA (US)

(72) Inventor: Thomas HSUEH, Anacortes, WA (US)

(21) Appl. No.: 13/987,590

(22) Filed: Aug. 12, 2013

Related U.S. Application Data
(60) Provisional application No. 61/742,597, filed on Aug. 15, 2012.

(51) Int. Cl. B64C 1/26

(52) U.S. Cl. CPC B64C 1/26
USPC 29/897.2

(57) ABSTRACT

A method is described of mating composite structures by means of straps, thus avoiding the use of through-structure fasteners and the need to drill holes through the composite structure. This method is applicable to any composite structures, but is particularly valuable for light weight composite aircraft wing-to-fuselage connections. The method described herein is for this particular application.

### RELATED APPLICATIONS

This application claims priority benefit of U.S. Provisional Application Ser. No. 61/742,597, filed Aug. 15, 2012 and incorporated herein by reference

### BACKGROUND OF THE INVENTION

The traditional method of joining an aircraft wing and fuselage is by bolting the two structures together. In the case of composite aircraft this requires the drilling of holes in the composite laminates through which bolts will be inserted. Some of the resulting problems are:
Drilling holes may cause delamination of the composite material
Cutting the material fibers will weaken the structure thus requiring additional material with resulting increase in weight
The bolts will create localized stress concentrations which may cause localized failures
Corrosion may occur between the bolt and composite material

### SUMMARY OF THE INVENTION

Disclosed herein is a simple, reliable and low cost method of mating the wings to the fuselage of a composite aircraft by means of steel or composite straps. This method avoids the use of through-structural fasteners and the need to drill holes through the composite structure and results in the following additional benefits:
Quick interchange of fuselages
Longitudinal movement of wing to adjust the aircraft c.g. location
Increased fuel volume in wing
Ease of manufacture
Weight reduction
Increased fatigue life
Reduced maintenance costs

### DESCRIPTION OF DRAWINGS

FIG. 1 Wing-fuselage connection showing the fuselage, wing, cradle and straps

FIG. 2 Fuselage cross-section showing the straps

FIG. 3 Wing box and longeron cross-section showing strap routing, bridge, and longeron bulkheads

FIG. 4 Longeron section showing routing of double straps through longeron

### DESCRIPTION OF THE PREFERRED EMBODIMENT

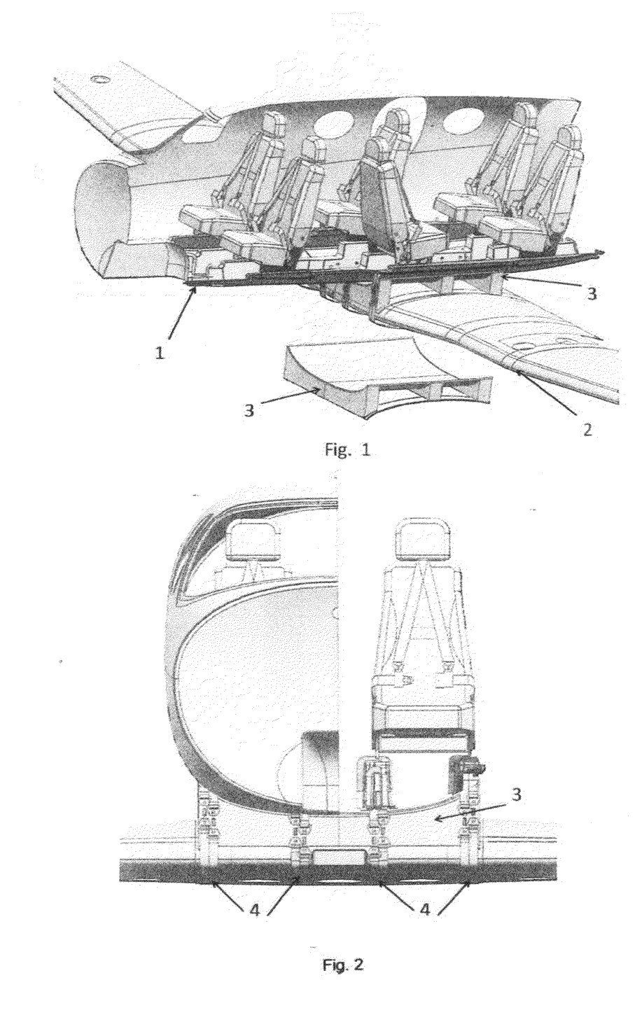

In the embodiment described herein, referring to FIG. 1, the fuselage 1 of the aircraft is positioned on top of the wing 2. A cradle 3 is positioned between the wing and the fuselage, the lower surface of the cradle matching the contour of the upper part of the wing and the upper surface of the cradle matching the lower surface of the fuselage. A sheet made of polymer or other material (not shown on figures) could be interposed between the cradle and the fuselage and between the cradle and the wing. In the current embodiment, a total of eight straps 4 (FIG. 2) wrap around the wing box and through four longerons (FIGS. 2, 3 and 4) in the floor of the fuselage, tying the wing, cradle and fuselage together. The number of straps and longerons will depend on any particular design configuration.

This method allows the mating of wings and fuselages of different shapes by simply using a new interface cradle and fairing. Fuselages with the same outer contour but different internal configurations (i.e. passenger, cargo, ambulance, military) can be mated to the same wing without a change of cradle. Potential applications for both military and commercial operators are almost limitless. With a twin boom design, power plants and pylons can stay with the wing and different mission equipment can be installed in different fuselages thus readying the aircraft for completely different missions. The operational cost of both manned and unmanned aircraft could thus be greatly reduced. If a fuselage is damaged, a spare one could be installed in minutes in the field.

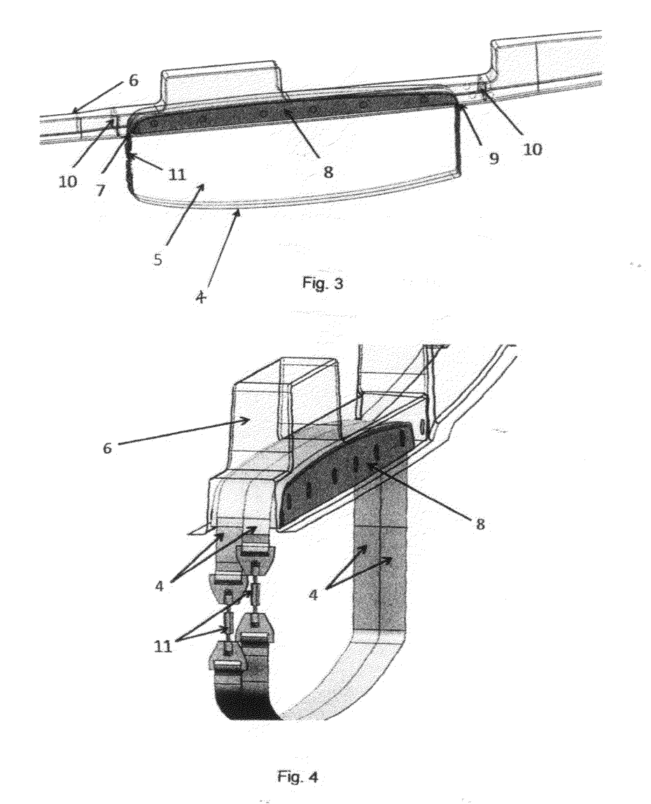

FIGS. 3 and 4 illustrate one method of routing straps around the wing and fuselage. Starting from the front of the wing box 5, where adjustable strap connectors 11 are located, the straps 4 (two per longeron in the current embodiment) enter a longerons 6 through an opening in the fuselage 7, wrap around a bridge 8 inside the longeron, exit the longeron through another opening 9 in the fuselage, and then wrap around the wing box back to the strap connectors.

For pressurized aircraft, bulkheads 10 inside each longeron forward and aft of the fuselage openings are provided to prevent air from escaping through these openings. The openings can be made long enough to allow small wing-body x axis position adjustments to optimize the aircraft center of gravity location. The bridge inside the longeron would be free to move in the fore and aft direction while these adjustments are made so as to maintain proper load distribution.

Recesses inside both the top and bottom of the cradle would be provided to house the polymer sheets with thickness and density calculated to provide evenly distributed pressure when the fuselage and wing are mated and clamped down by the strap tensioners. The constant pressure on the polymer sheets generates frictional forces, which together with the shape factor of the cradle, amply counter any torsional force between the wing and fuselage. The longerons also provide a good attachment base for concentrated loads coming from the seat legs, cargo rings etc. They also contribute greatly to the strength of the fuselage. Quick tension adjustable strap connectors can be used if necessary. The tension of the straps can be controlled by a simple torque wrench.

While the present invention is illustrated by description of one method of attaching an aircraft wing to its fuselage by means of straps, it is not the intension of the applicant to restrict or in any way limit the scope of the appended claims to such a particular so method. Additional advantages or modifications within the scope of the appended claims will readily appear to those having ordinary skill in the art. The invention in its broader aspects is therefore not limited to the specific details, type of airborne vehicles and illustrative examples shown and described. Accordingly, departures may be made from such details without departing from the spirit or scope of the applicant's general concept.

Therefore I claim

1. A method of connecting the wings and fuselage of a composite aircraft or other airborne vehicle without the necessity of drilling holes through the composite structure, further comprising
a: The use of steel or composite straps to achieve the objective of the claim.
b. The specific method for routing the straps through a longeron, including the use of a movable bridge, as described.
c. Any other method of routing the straps to achieve the same objective.
d. The use of slots of variable length in the longerons to allow x-axis positioning of the wing relative to the fuselage.
e. The use of a standard cradle to allow aircraft or other airborne fuselages with the same outer contour but different internal configurations to be mated to the same wing.
f. The use of customized cradles positioned between the wing and fuselage of aircraft or other airborne vehicle to allow the mating of wings and fuselages of different shapes.
g. The use of sheets made of polymer or other material interposed between cradle and fuselage and between cradle and wing.
